(19) United States
(12) Patent Application Publication
(10) Pub. No.: US 2010/0101663 A1
(43) Pub. Date: Apr. 29, 2010

(54) SYSTEM AND METHOD FOR PIPELINE HEATING

(76) Inventor: Bertil Granborg, Incline Village, NV (US)

Correspondence Address: LEWIS AND ROCA LLP, 1663 Hwy 395, Suite 201, Minden, NV, 89423, US

(21) Appl. No.: 12/258,198

(22) Filed: Oct. 24, 2008

(51) Int. Cl. F16L 53/00; H05B 6/10

(52) U.S. Cl. 137/341; 219/643; 138/33; 219/535

(57) ABSTRACT

A fluid flow within a transportation pipeline is heated with low voltage, high current electrical energy induced into a conductive closed loop structure by one or more transformers. The closed loop structure is preferably a fluid transportation pipeline constructed of electrically conductive sections of pipeline. The amount of current induced is sufficient in relation to the inherent resistivity of the conductive sections to cause the generation of heat within the pipeline sections. By conductive and convective heat transfer, the heat induced into the pipeline structure is transferred to a fluid flow within the pipeline. The current is preferably an alternating current of frequency which causes a majority of the current to travel at or near the outer surfaces of the pipeline sections which increases the effective resistivity of the sections and heat generation therein.

### FIELD OF THE INVENTION

The present invention relates to a system and method using inherent resistivity of electrically conductive sections of a pipeline to generate heat within the pipeline. Specifically, the present invention relates to using the generated heat within the pipeline to heat a fluid flowing therein to facilitate transportation of the fluid between one or more distant locations. More specifically, the present invention relates to using the pipeline as a power distribution line to provide auxiliary power to remote pipeline locations.

### BACKGROUND OF THE INVENTION

Fluid transportation pipelines have long been used to deliver various fluids over long distances. One common application for a fluid transportation pipeline is an oil pipeline which is used to transport crude oil from an extraction site to a distant refinery or secondary transportation system. However, the transportation of crude oil using long pipelines presents several technological obstacles that must be overcome for the transportation of the crude oil to be practical.

One significant problem is that the viscosity of the crude oil may decrease during transportation and becomes extremely more difficult to move through the pipeline. The difficulty primarily occurs due to increased fluid friction and surface tension within the pipeline caused by a decrease in oil temperature. The temperature loss occurs when the crude oil which usually enters the pipeline at a high temperature, cools off of over time and distance traveled. For example, when the oil is extracted from below ground, it is usually at a high-temperature and at a low-viscosity that facilitates fluid flow through the pipeline. However, the oil cools as it is being transported over long distances though a pipeline. This situation is amplified with pipelines used in cold weather artic environments, the viscosity of the oil increases and transportation becomes problematic over short spans of pipeline. Fluid dynamics provides that the viscosity of the oil increases exponentially with decreasing temperature. A high-temperature/low-viscosity oil can be pumped and transported through the pipeline using substantially less energy then a low-temperature/high-viscosity oil due to reduced friction, surface tension and pumping requirements.

Another significant problem is that the temperature change in the crude oil during transportation may cause blockage or substantial obstruction of the pipeline. The blockage or obstruction occurs when the crude oil, which usually enters the pipeline at a high-temperature, cools to a lower temperature, which promotes the formation of hydrates and precipitation of paraffins. This formation and precipitation of hydrates and paraffins can significantly obstruct the fluid flow within the pipeline. In extreme conditions, the obstruction can completely prevent the fluid flow within the pipeline. If the pipeline is completely blocked, other problems arise such as an increase in pipeline pressure, which may cause structural failure of the pipeline leading to oil leakage into the surrounding environment.

Consequently, efforts to provide an efficient, cost effective and convenient temperature control of a fluid within a transportation pipeline have not met with much success to date.

### SUMMARY OF THE INVENTION

The present invention facilitates the transportation of a fluid within a pipeline by providing a system and method for heating the pipeline and indirectly heating the fluid flow within the pipeline.

In accordance with one aspect of the present invention, a system is provided for generating heat in an electrically conductive pipe comprising a means for causing an alternating current through the pipe, the current being sufficient in relation to an inherent resistivity of said element to generate a desired amount of heat. The alternating current can be induced and a means for inducing the current can be a source of alternating voltage which is transformed into alternating current, the alternating voltage being applied to a primary winding of a transformer and the pipe being serially within an electric current loop.

In another exemplary embodiment of the present invention, a pipeline may be sectionalized. Connecting switches may be used to open or close a portion of the pipeline. By closing a portion of the pipeline (by closing one or more connecting switches), that individual section of the pipeline can be heated separate from the rest of the pipeline.

In another exemplary embodiment of the present invention, a pipeline activated with electric current can be used as a power source. In accordance with aspects of preferred embodiments, a transformer may be used to draw power off of the pipeline by induction. This power may then be used to power devices, such as, for example, a pump.

In yet another embodiment of the present invention, a thermostat controller may be used to more accurately control the temperature of a pipe being heated. A bi-metal disc may be used to cause a switch contact to open if a upper limit temperature is reached, thereby disconnecting a power source from transformers providing current to the pipe. When the pipe has cooled to the lower temperature limit, the switch will close and the power will be once again connected to the system, thus enabling the pipe to be heated once again.

For a more complete understanding of the nature and various advantages of the present invention, reference should be made to the ensuing detailed description and claims, taken in conjunction with the accompanying drawings.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a system schematic illustrating an exemplary embodiment in accordance with the present invention utilizing distributed power supplies;

FIG. 2 is a system schematic illustrating an exemplary embodiment in accordance with the present invention utilizing a sectionalized pipeline;

FIG. 3 is a cross sectional view illustrating an exemplary split-toroid transformer surrounding a pipe;

FIG. 4 is a system schematic illustrating an exemplary embodiment in accordance with the present invention utilizing a thermostat controller system;

FIG. 5 is a system schematic illustrating an exemplary embodiment in accordance with the present invention utilizing a pipeline for distal power distribution.

### DETAILED DESCRIPTION OF THE INVENTION

The present invention facilitates the transportation of a fluid within a pipeline by providing a system and method for heating the pipeline and indirectly heating the fluid flow therein. In the following description, numerous specific details are set forth in order to provide a more thorough description of the present invention. It will be apparent, however, to one skilled in the art, that the present invention may be practiced without these specific details. Other embodiments of the invention will readily suggest themselves to such skilled persons having the benefit of this disclosure. In some instances, well-known features have not been described in detail so as not to obscure the invention.

The present invention provides several advantages for fluid pipeline transportation systems. For example, the system and method of the present invention provides heat for a fluid flowing within the pipeline to thereby facilitate transportation of the fluid therein; the system and method reduces the energy consumption used in pumping the fluid by keeping the fluid at a high temperature and low viscosity; and the present invention prevents undesirable formation of hydrates and precipitation of paraffins which may obstruct the pipeline. Finally, the system and method of the present invention provides a power distribution system for energizing pumping stations located a substantial distance downstream of a primary pumping station.

Steel pipes are used to transport of natural gas, crude oil, and other products long distances. These pipes may be used as electric heating elements to maintain an appropriate temperature for the product being carried.

In preferred embodiments of the present invention, alternating electrical energy is applied to the primary of a stepdown transformer in which a secondary winding produces high current and low voltage in a circuit made up of structural elements or sequences of the serially connected. In preferred embodiments, the high current preferably alternates a frequency high enough to generate heat by the resistive losses close to the surface of the conductive elements due to skin effect, which concentrates the current at or near the surface.

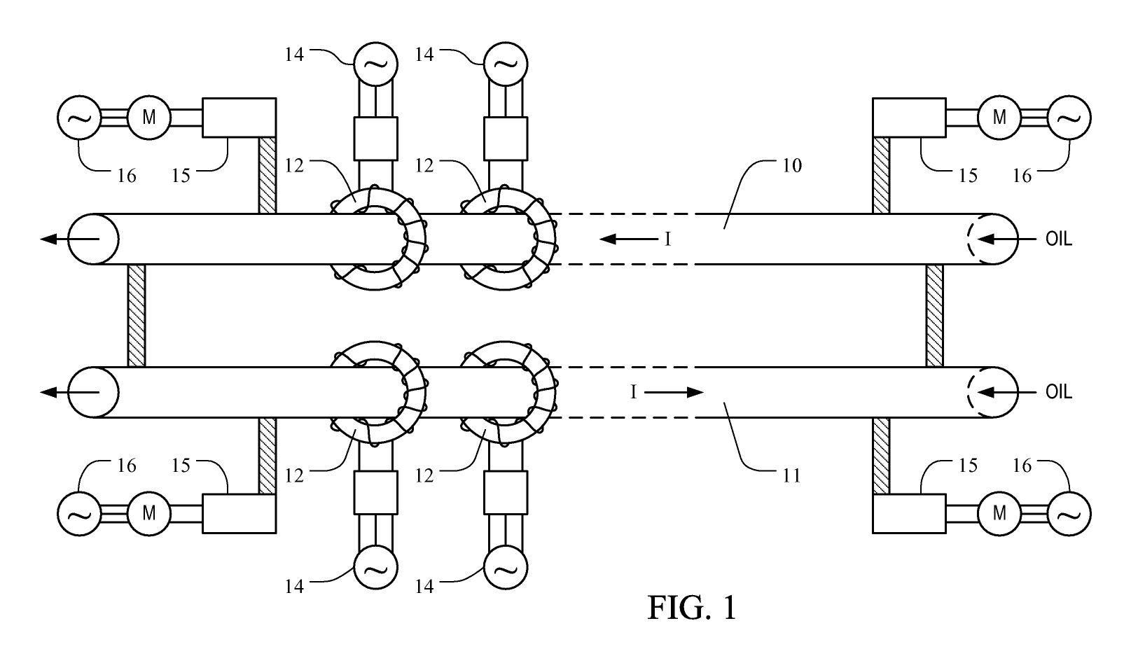

An embodiment of the present invention is shown in FIG. 1, which illustrates two conductive pipes 10 and 11 running parallel. In the embodiment shown, one or more transformers 12 are attached to the pipes 10 and 11. In one embodiment of the present invention, the transformers are toroid transformers. A power source 14 energizes the primary of the transformer 12. The power source 14 may comprise any electrical source, such as, for example, a small diesel-electric generator, a steam-turbine generator, a gas-turbine generator, a large power station, and the like. A current will be induced in the conductive pipes, thereby heating pipes 10 and 11. Any number of transformers may be used in the present invention. In addition pipes 10 and 11 may be connected via connection members 18.

With continued reference to FIG. 1, an exemplary embodiment of the present invention may have on or more pump stations 15. Pump stations 15, powered by power source 16, help force the product through the pipes.

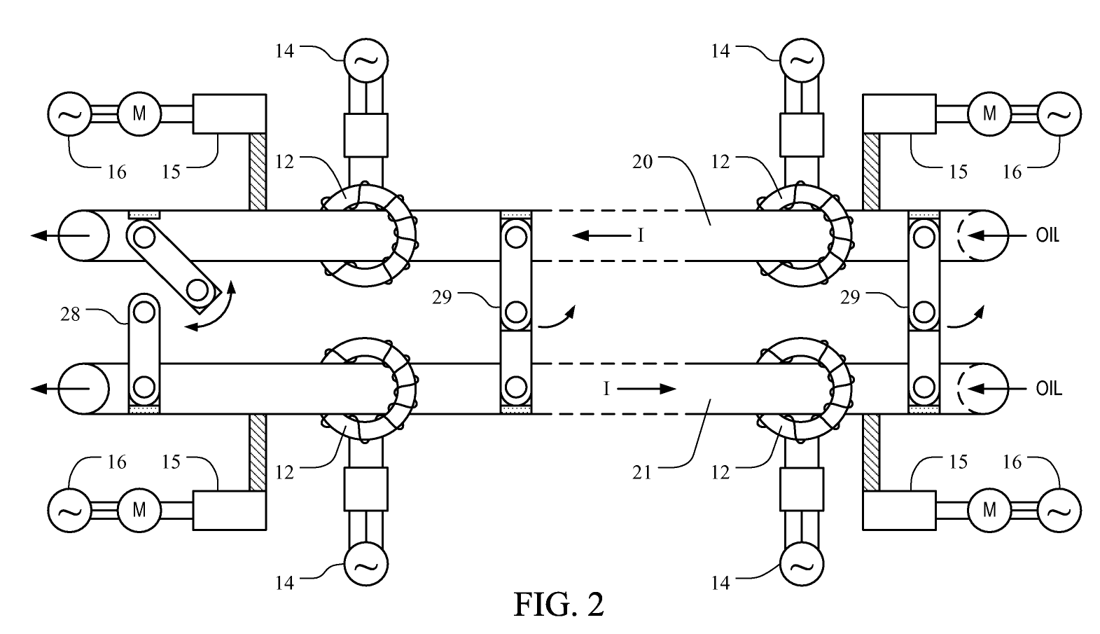

In another embodiment of the present invention, it may be advantageous to sectionalize the pipeline, thus enabling a part of the pipeline to be heated individually, or, alternatively, a series of sections may be heated. FIG. 2. shows an exemplary embodiment of the present invention in which the pipeline is sectionalized.

Similar to the embodiment of FIG. 1, FIG. 2 shows two pipes 20 and 21 running adjacent to one another, one or more transformers 12 (connected to one or more power sources 14), and possible pumping stations 15 and their respective power sources 16. It should be noted that the power source for the transformers and the power source for a pumping station could be the same source or different sources. It should also be noted that there may be different power sources for different transformers, just as there may be different power sources for different pumping stations. In accordance with aspects of this embodiment, the transformers may be toroid transformers.

FIG. 2 illustrates that the two pipes 20 and 21 have connecting switches 28 and 29 connected to them. The connecting switches may either be open 28 or closed 29. The connecting switches are used create an individual section of the pipeline that can be heated separately from other sections of the pipeline. For example, FIG. 2 illustrates an section of the pipeline that may be heated individually. The current from the transformers will flow between the two closed connecting switches 29. Thus, the section of pipeline between the two connecting switches will be heated independently from the rest of the pipeline.

The connecting switches between the two pipes 20 and 21 may be open and closed manually. In another preferred embodiment of the present invention, the connecting switches may be positioned in the open and closed positions (28 and 29) automatically.

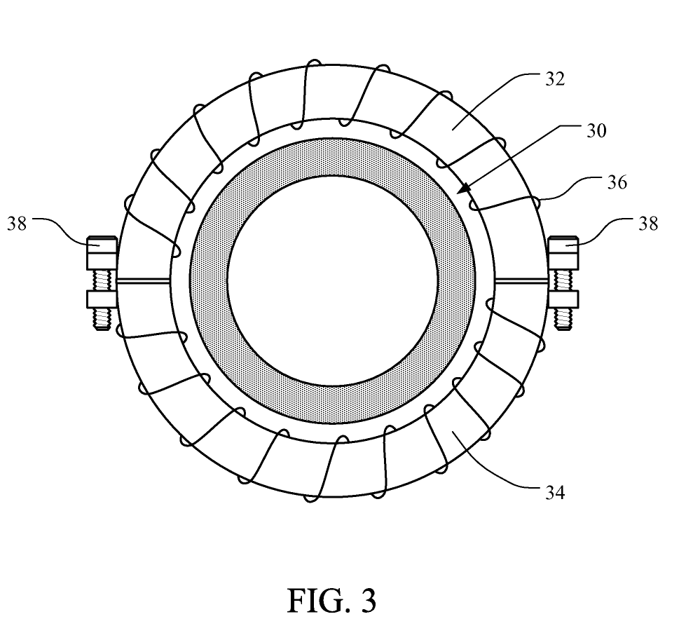

With reference to FIG. 3, according to preferred embodiment of the present invention, the transformers used to heat the pipes may be toroid transformers. Due to the magnitude of the transformer needed, the toroid may have a split core to assemble the system. Therefore, a first portion of the toroid transformer 32 and a second portion of the toroid transformer 34 may be assembled together around pipe 30. According to aspects of preferred embodiments, the two portions of the toroid transformer, 32 and 34, may be assembled with hinged or screw connections. For example, FIG. 2 shows the two portions 32 and 34 being held together by screw fasteners 38. It should be noted, that any means of fastening the two portions of the toroid transformer may be used. Each of the two portions of the transformer has windings 36.

In addition, each of the pipes shown in the embodiments of the present invention must have a sufficient electric insulation and thermal-insulation material. An example of a preferred insulation material, which was developed by NASA, reflects approximately 97% of the radiant heat back to the pipe.

In most cases, the temperature of the pipes can be controlled by regulating the real power that is fed to the pipes. One or more power supplies may be connected to the system until a steady state temperature has been reached.

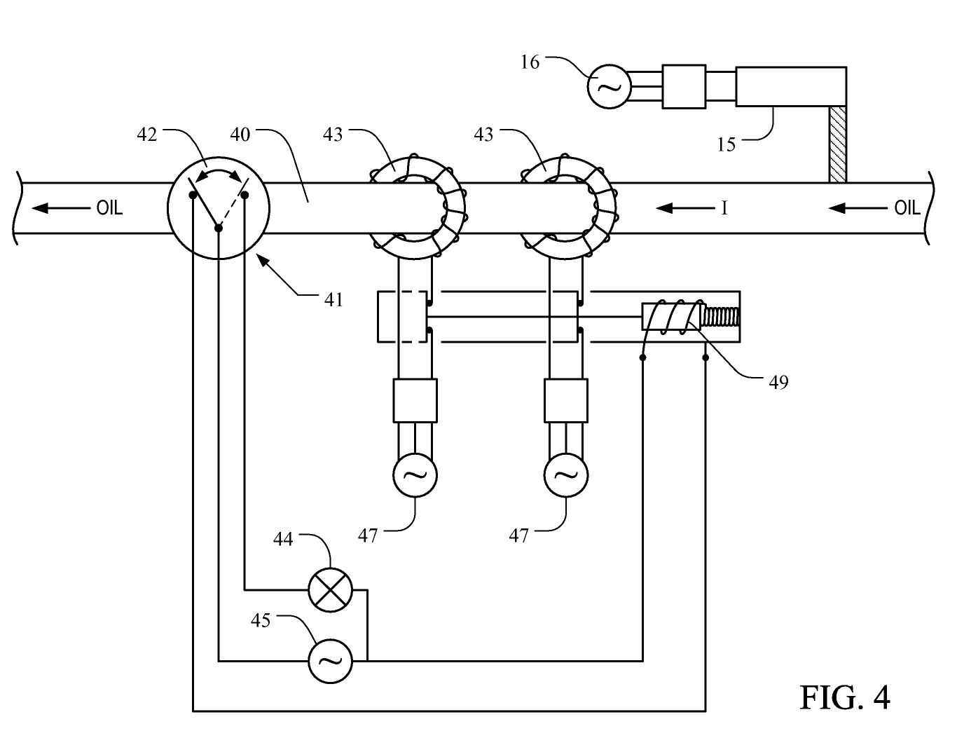

However, a thermostat controller may be used on any pipe to increase the accuracy of the temperature control. An exemplary embodiment of such a system is illustrated in FIG. 4. One or more power supplies 47 will energize the pipe 40 via one or more transformers 43. The power supply 47 will continue to energize the pipe until an upper temperature limit is reached. Once the upper temperature limit has been reached in the pipe, a controller 42, which preferably comprises a temperature sensitive bi-metal disc in an epoxy sealed housing, will activate a plunger causing a heavy duty switch contact 41 to open. The power supply 47 will then be disconnected from the one or more transformers 43 via relay 49. A lamp 44 may be present and will indicate whether the upper temperature limit has been reached and the power supply 47 has been disconnected.

After being disconnected from the power supply 47, the temperature in the pipe will decrease. After a certain period of time, the temperature will reach the lower temperature limit, at which time the switch 41 will reconnect the power supply 47. The power supply 47 will be connected and heat the system until the upper temperature limit is reached once again and the power supply is then disconnected. The controller and lamp are powered by thermostat power supply 45, which may or may not be the same as the power supply 47 used to heat the system.

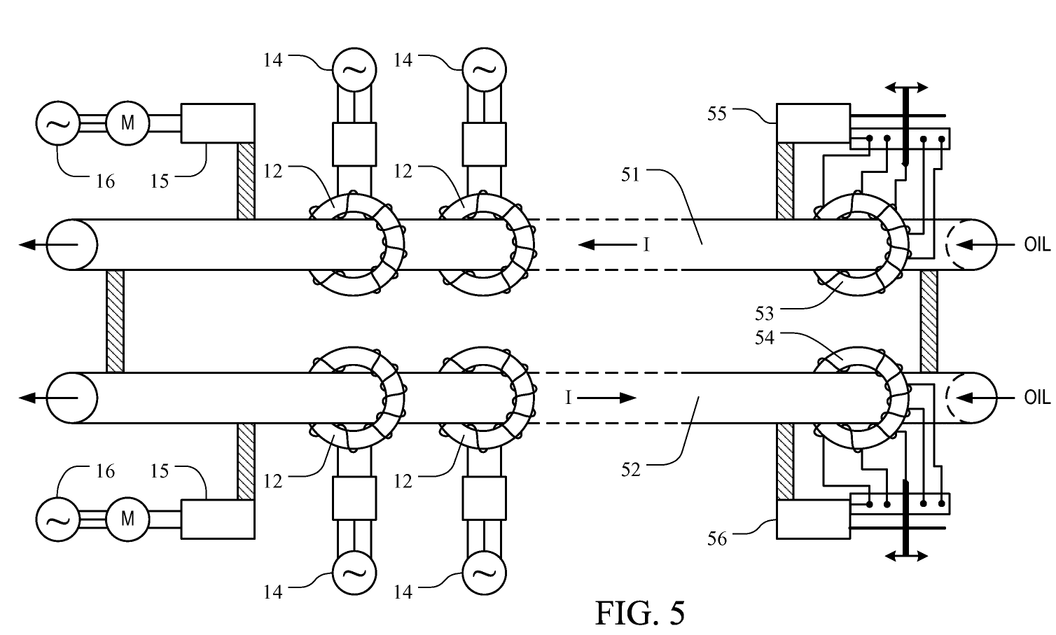

In many instances pipelines may not be in a close proximity to a power source, or it may be more convenient or cost effective to use an alternative source. FIG. 5 illustrates an exemplary embodiment of the present invention, in which the pipeline may serve as a power source. Once the pipeline has been activated as discussed above, it can serve as a transmission line. Power may be transferred from a pipe 51 or 52 to a toroid transformer 53 or 54 by induction. That power may then be used to power an electric pump motor 55 or 56. The power adjustment could be made by personnel at a pump station by using transformer taps. It should be noted that power pulled off of the pipeline can be used to power items other that pumps.

Although the above provides a full and complete disclosure of the preferred embodiments of the invention, various modifications, alternate constructions and equivalents will occur to those skilled in the art. Therefore, the above should not be construed as limiting the invention, which is defined by the claims.

What is claimed is:

1. A heating system for use with a fluid transportation pipeline comprising:
at least one electrically conductive pipe;
means for heating the electrically conductive pipe comprising:
at least one source of electrical energy; and
at least one electrical transformer; and
at least one connecting switch; wherein at least one connecting switch can be closed to create a sectionalized portion of the at least one electrically conductive pipe that can be heated independently of the rest of the at least one electrically conductive pipe.

2. The system according to claim 1, wherein the transformer is a toroid transformer.

3. The system according to claim 2, wherein the toroid transformer is a split toroid transformer.

4. The system according to claim 1, wherein the at least one connecting switch is open and closed manually.

5. The system according to claim 1, wherein the at least one connecting switch is open and closed automatically.

6. The system according to claim 1, further comprising a thermostat controller to regulate the temperature of the at least one electrically conductive pipe.

7. A system for use with a fluid transportation pipeline comprising:
at least one electrically conductive pipe;
at least one power source;
at least one transformer to electrically activate at least one electrically conductive pipe;
at least one electrical load; and
at least one transformer connected to the at least one electrically conductive pipe to couple electrical power from the at least one electrically conductive pipe to the at least one electrical load.

8. The system according to claim 7, wherein the at least one receiving device is a pump.

9. The system according to claim 7, wherein the at least one transformer is a toroid transformer.

10. The system according to claim 9, wherein the toroid transformer is a split toroid transformer.

11. The system according to claim 7, wherein the at least one transformer connected to the at least one electrically conductive pipe to couple electrical power from the at least one electrically conductive pipe to the at least one electrical load is a toroid transformer.

12. The system according to claim 11, wherein the at least one toroid transformer connected to the at least one electrically conductive pipe to couple electrical power from the at least one electrically conductive pipe to the at least one electrical load.

13. A heating system for use with a fluid transportation pipeline comprising:
at least one electrically conductive pipe;
means for heating the at least one electrically conductive pipe comprising:
at least one source of electrical energy; and
at least one electrical transformer; and
a thermostat controller to regulate the temperature of the at least one electrically conductive pipe.

14. The system according to claim 13, wherein the thermostat controller comprises a temperature sensitive bi-metal disc.

15. The system according to claim 14, wherein the thermostat controller further comprises a plunger that causes a heavy duty switch to open when the temperature of the pipe reaches an upper limit temperature.

16. The system according to claim 15, wherein the thermostat controller further comprises a lamp to indicate that the upper temperature limit has been reached and that the source of electrical energy has been disconnected from the at least one electrical transformer.

17. The system according to claim 13, further comprising at least one connecting switch; wherein at least one connecting switch can be closed to create a sectionalized portion of the at least one electrically conductive pipe that can be heated independently of the rest of the pipeline.

18. The system according to claim 13, further comprising at least one electrical load and at least one transformer connected to the at least one electrically conductive pipe to couple electrical power from the at least one electrically conductive pipe to the at least one electrical load.

19. The system according to claim 19, wherein the at least one electrical load is a pump.

20. The system of claim 13, wherein the at least one transformer connected to the at least one electrically conductive pipe to couple electrical power from the at least one electrically conductive pipe to the at least one electrical load is a toroid transformer.
